(19) United States
(12) Patent Application Publication
(10) Pub. No.: US 2015/0059656 A1
(43) Pub. Date: Mar. 5, 2015

(54) AUTOMATIC CLEANING AND HAIR-REMOVING SLANTED BRUSH

(71) Applicant: Lin Jui-Tsang, Shenzhen (CN)

(72) Inventor: Lin Jui-Tsang, Shenzhen (CN)

(21) Appl. No.: 14/010,566

(22) Filed: Aug. 27, 2013

(51) Int. Cl. A01K 13/00

(52) U.S. Cl. CPC A01K 13/002; A46B 2200/1093
USPC 119/633; 15/160

(57) ABSTRACT

An automatic cleaning and hair-removing slanted brush contains: a bristle holder, a comb plate and a reciprocating moving plunger. The bristle holder includes a fixed bristle surface and an opposite back side. The comb plate includes a row of bristle holes corresponding to the bristles. The middle part of the bristle holder includes through holes. The comb plate has connecting rods parallel to the bristles. Each connecting rod has a first buckle structure. The ends of the connecting rods are attached to the second buckle structures on the reciprocating moving plunger after passing through the through holes, so the reciprocating moving plunger and the comb plate are fixed. The bristles of the automatic cleaning and hair-removing slant brush are fixed on a slanted angle to the fixed bristle surface. The bristles have an inclined angle with the fixed bristle surface, so that its strength when brushing pet hairs is re-enforced.

### BACKGROUND OF THE INVENTION

1. Technical field

The utility model pertains to a comb for pets.

2. Background technology

Along with the growth of people's living standard, pets have become more and more popular; and moreover, because of the speeding-up of the pace of life and the increasing competitive pressure, keeping pets is now common in many families. Most of the combs used for brushing pet hairs are ordinary combs. However, pets have numerous hairs, and many pet hairs are often wound on the comb during combing and must be removed slowly, which results in a waste of time, waste of labor and messy pet hairs. Although some pet brushes are used for combing pet hairs in a pressing manner and can be used for combing pet hairs with different thicknesses, and the bristles of the existing combs for combing pet hairs are vertically fixed on the fixed bristle surface. The strength for combing pet hairs is often inadequate and the complete removing effect cannot be achieved.

### CONTENT OF THIS UTILITY MODEL

With respect to the above conditions, it is necessary to provide a pet hair-removing slanted brush which is convenient to use and has better combing effect.

For solving the above technical problems, an automatic cleaning and hair-removing slanted brush is provided, comprising a bristle holder, a comb plate and a reciprocating moving plunger. The bristle holder has a fixed bristle surface and an opposite back side. The bristles are fixed on a slanted angle to the fixed bristle surface. The comb plate is provided with bristle holes corresponding to the bristles. The middle part of the bristle holder is provided with through holes. The comb plate is provided with connecting rods that are parallel with the bristles. One end of each connecting rod is provided with a first buckle structure and the ends of the connecting rods with the first buckle structures are attached to the second buckle structures on the reciprocating moving plunger after passing through the through holes. The reciprocating moving plunger and the comb plate are fixed.

The connecting rods and the side of the comb plate are arranged in an inclined angle of 40-80 degrees.

The bristles and the fixed bristle surface are located at an inclined angle of 40-80 degrees.

An anti-slip positioning frame is arranged on a slanted angle on the back side of the bristle holder. The anti-slip positioning frame is a rectangular groove with an opening on one side. The through holes of the bristle holder are arranged on the anti-slip positioning frame. The reciprocating moving plunger is wrapped by the anti-slip positioning frame and the height of the reciprocating moving plunger is less than that of the anti-slip positioning frame.

The anti-slip positioning frame and the back side of the bristle holder have an inclined angle of 40-80 degrees.

The anti-slip positioning frame is parallel with the connecting rods.

The back side of the bristle holder is provided with a raised column. The raised column is parallel with the connecting rods and is arranged in the middle of the through holes. An elastic element is arranged between the raised column and the reciprocating moving plunger. One end of the elastic element is buckled on the raised column and the other end is abutted against the reciprocating moving plunger.

The back side of the bristle holder is provided with a handle connector which is connected with a hollow comb handle. A fixed rib is located in the middle of the hollow comb handle. The edges of the two ends of the hollow comb handle are respectively provided with an anti-slip edge.

The stroke of the reciprocating plunger is more than the vertical length of the bristles.

According to the automatic cleaning and hair-removing slanted brush provided by the utility model, the anti-slip positioning frame is arranged outside the reciprocating moving plunger. When the brush is in use, because the reciprocating moving plunger is arranged in the anti-slip positioning frame, this positioning frame plays a role in guiding the reciprocating moving plunger. When in motion, the reciprocating moving plunger can only move in the anti-slip positioning frame in the direction of the elastic element. The bristles are fixed on a slanting angle on the fixed bristle surface. The anti-slip positioning frame, the raised column and the elastic element are parallel with the bristles. When the slanted brush is being used, the reciprocating moving plunger is pressed and the pressing force is directly applied on the bristles, so that the strength of combing pet hairs is strengthened.

The bristles and the fixed bristle fixed surface are inclined at a certain angle. When the incline is an acute angle, the force at the combing contact points is focused and the complete cleaning effect can be achieved.

### DESCRIPTION OF FIGURES

FIG. 1 is the structural diagram of the explosion of the automatic cleaning and hair-removing slanted brush.

FIG. 2 is the integral structural diagram of the automatic cleaning and hair-removing slanted brush.

FIG. 3 is the structural diagram of the bristle holder of the automatic cleaning and hair-removing slanted brush.

FIG. 4 is the structural diagram of another view of the bristle holder of the automatic cleaning and hair-removing slanted brush.

FIG. 5 is the structural diagram of another view of the bristle holder of the automatic cleaning and hair-removing slanted brush.

FIG. 6 is the structural diagram of the comb plate of the automatic cleaning and hair-removing slanted brush.

FIG. 7 is the structural diagram of the reciprocating moving plunger of the automatic cleaning and hair-removing slanted brush.

Included: bristle holder (10); fixed bristle surface (102); back side (104); bristles (12); anti-slip positioning frame (14); handle connector (16); raised column (18); through hole (19);

Comb plate (20); connecting rod (22); bristle hole (24); first buckle structure (222);

Elastic element (30);

Reciprocating moving plunger (40); second buckle structure (42);

Hollow comb handle (61); fixed rib (612); anti-slip edge (614); and automatic cleaning and hair-removing slanted brush (100).

### Specific Mode of Execution

The automatic cleaning and hair-removing slanted brush (100) provided by the utility model is further described in detail with the following figures and the embodiment.

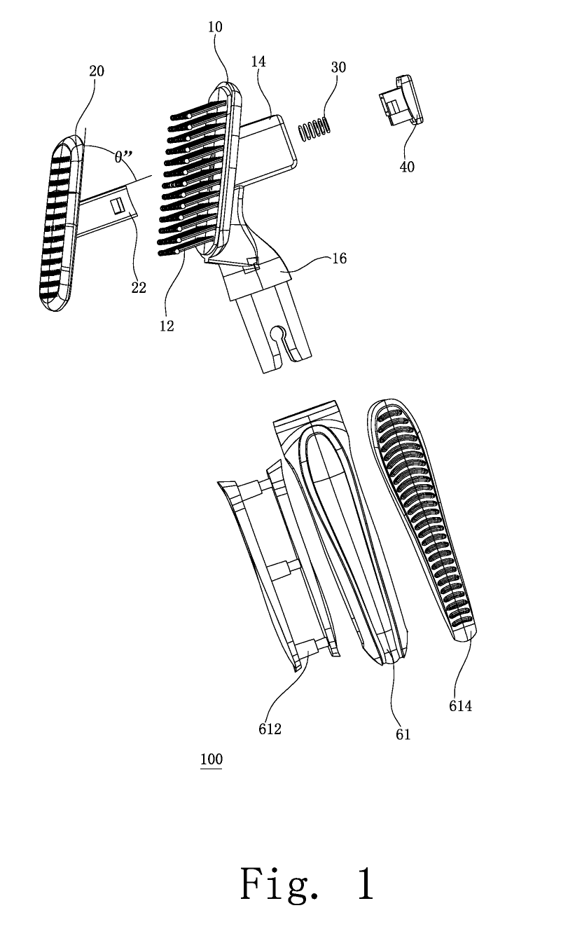

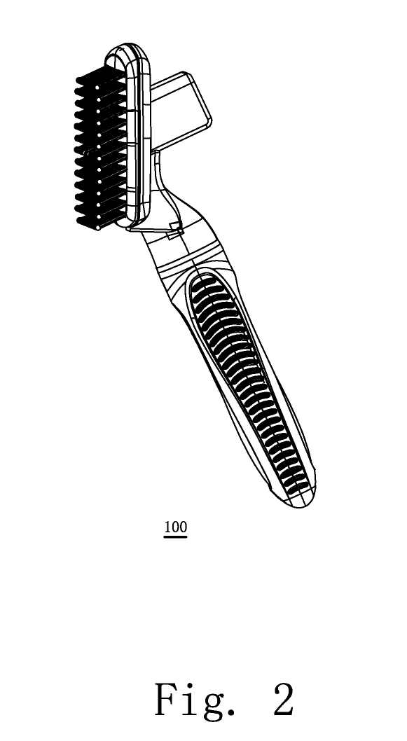

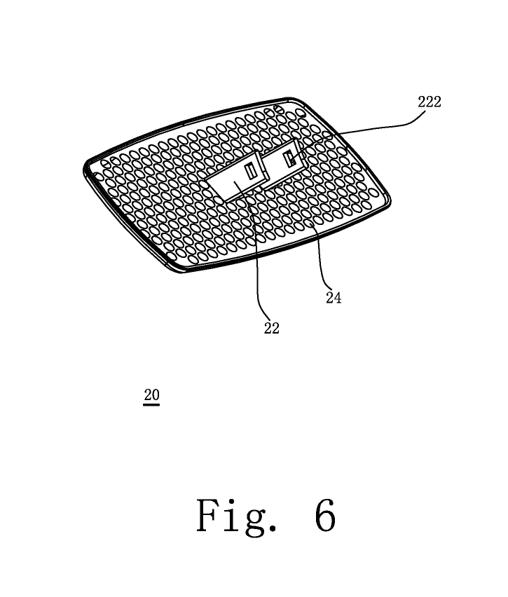

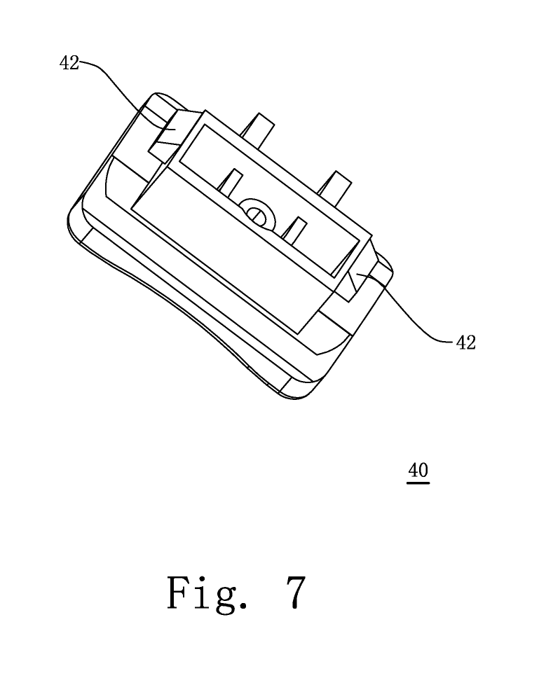

In FIG. 1, FIG. 2, FIG. 6 and FIG. 7, the automatic cleaning and hair-removing slanted brush (100) of the embodiment comprises the bristle holder (10), the comb plate (20) and the reciprocating moving plunger (40); the bristle holder (10) comprises the fixed bristle fixed surface (102) and the back side (104) opposite the fixed bristle fixed surface (102); the bristles (12) are fixed aslant on the fixed bristle surface (102); the comb plate (20) is provided with rows of bristle holes (24) corresponding to the bristles (12); the middle part of the bristle holder (10) is provided with the through holes (19); the comb plate (20) is provided with the connecting rods (22); the connecting rods (22) are parallel with the bristles (12); one end of each connecting rod (22) is provided with the first buckle structure (222); and the ends of the connecting rods (22) with the first buckle structures (222) are attached to the second buckle structures (42) on the reciprocating moving plunger (40) after passing through the holes (19), so that the reciprocating moving plunger (40) and the comb plate (20) are fixed.

In FIG. 1, the connecting rods (22) and the comb plate (20) are arranged in an inclined angle Theta″ of 40-80 degrees. The angle between the connecting rods (22) and the side of the comb plate (20) is consistent with that between the bristles (12) and the fixed bristle surface (102).

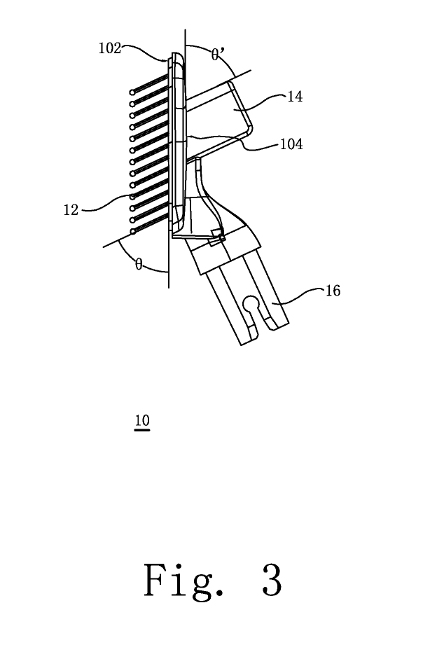

In FIG. 3, the bristles (12) and the fixed bristle surface (102) are arranged on a fixed inclined angle Theta of 40-80 degrees.

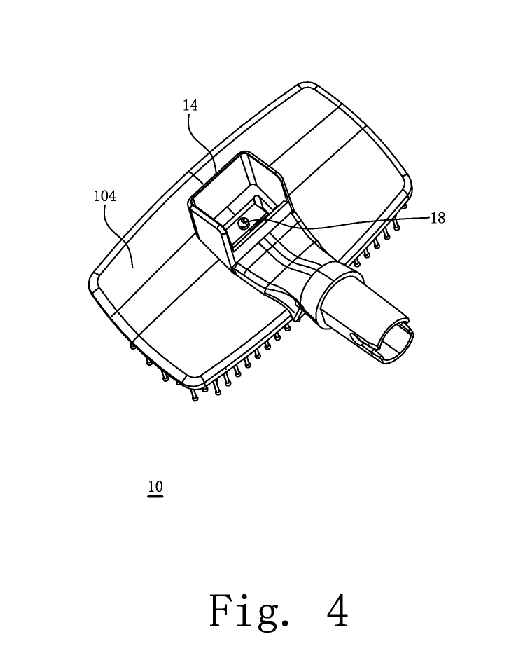

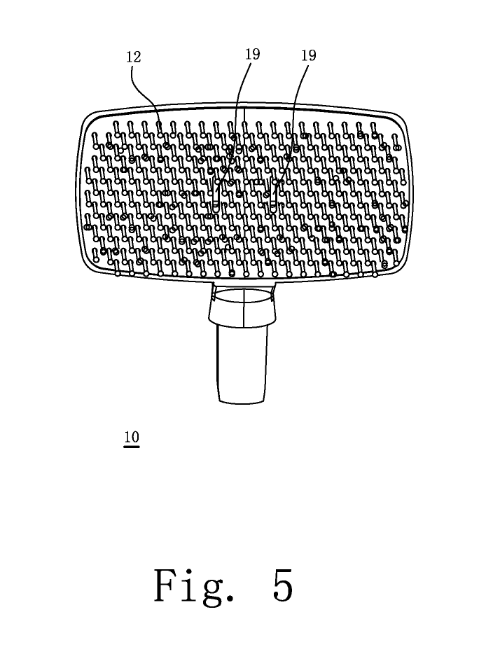

In FIG. 4 and FIG. 5, the anti-slip positioning frame (14) is arranged on a slanted angle on the back side (104) of the bristle holder (10) and plays a role in guiding the reciprocating moving plunger (40). The anti-slip positioning frame (14) is a rectangular groove with an opening on one side. The through holes (19) of the bristle holder (10) are arranged in the anti-slip positioning frame (14). The reciprocating moving plunger (40) is wrapped by the anti-slip positioning frame (14). The anti-slip positioning frame (14) is parallel with the connecting rods (22). When moving in unison, the reciprocating moving plunger (40) can only move in the anti-slip positioning frame (14). Moreover, the height of the reciprocating moving plunger (40) after being assembled is less than that of the anti-slip positioning frame (14).

In FIG. 3, the anti-slip positioning frame (14) and the back side (104) of the bristle holder (10) have an inclined angle Theta′ of 40-80 degrees.

The back side (104) of the bristle holder (10) is provided with a raised column (18). The raised column (18) is parallel with the connecting rods (22) and is arranged in the middle of the through holes (19). An elastic element (30) is arranged between the raised column (18) and the reciprocating moving plunger (40). One end of the elastic element (30) is buckled on the raised column (18) and the other end of the elastic element (30) is abutted against the reciprocating moving plunger (40).

In FIG. 1, the back side (104) of the bristle holder (10) is provided with a handle connector (16). The handle connector (16) is connected with a hollow comb handle (61). A fixed rib (612) is located in the hollow comb handle (61). The strength of the whole handle can be re-enforced by the fixed rib (612) and the edges at the two ends of the hollow comb handle (61) are respectively provided with anti-slip edges (614), so that the frictional coefficient between a hand and the slanted brush can be increased and the slip-off is prevented when the slanted brush is used.

The stroke of the reciprocating moving plunger (40) is more than the vertical length of the bristles (12) When the reciprocating moving plunger (40) is pressed, the bristles (12) are not exposed outside the comb plate (20) and a better hair-removing effect is realized.

According to the automatic cleaning and hair-removing slanted brush (100) provided by the utility model, the anti-slip positioning frame (14) is arranged outside the reciprocating moving plunger (40). When the automatic cleaning and hair-removing slanted brush (100) is used, because the reciprocating moving plunger (40) is arranged in the anti-slip positioning frame (14), the frame (14) plays a role in guiding the reciprocating moving plunger (40) and the plunger (40) can only move in the anti-slip positioning frame (14) when moving in the direction of the elastic element (30). The bristles (12) are fixed aslant the fixed bristle fixed surface (102). The anti-slip positioning frame (102), the raised column (18) and the elastic element (30) are parallel with the bristles (12). When the slanted brush is used, the reciprocating moving plunger (40) is pressed and the pressing force is directly applied on the bristles, so that the strength of combing the pet hairs is strengthened. The bristles (12) and the fixed bristle surface (102) are inclined for a certain angle Theta. When the inclined angle Theta is an acute angle, the force at the combing contact points is focused and the complete cleaning effect can be achieved.

The above description is the best embodiment of the utility model and has no any form of limitations to the utility model. Although the better embodiment of the utility model has been disclosed as the above, the better embodiment is not used for restricting the utility model. Without departing from the range of the technical scheme of the utility model, any technician familiar with the technology can change or modify the disclosed technical content into any equivalent embodiments. Without departing from the contents of the technical scheme of the utility model, any simple amending, equivalent changing and modifying to the above embodiment on the basis of the technical essence of the utility model is still within the range of the technical scheme of the utility model.

What is claimed is:

1. Au automatic cleaning and hair-removing slant brush, comprising a bristle holder, a comb plate and a reciprocating moving plunger, wherein the bristle holder comprises a bristle fixed surface and a back side opposite to the bristle fixed surface; bristles are fixed aslant on the bristle fixed surface; the comb plate is provided with bristle holes corresponding to the bristles; the middle part of the bristle holder is provided with through holes; the comb plate is provided with connecting rods; the connecting rods are parallel with the bristles; one end of each connecting rod is provided with a first buckle structure; and the ends of the connecting rods with the first buckle structures are buckled with second buckle structures on the reciprocating moving plunger after passing through the through holes, so that the reciprocating moving plunger and the comb plate are fixed.

2. The automatic cleaning and hair-removing slant brush according to claim 1, wherein the connecting rods and the side of the comb plate are arranged in an inclined angle of 40-80 degrees.

3. The automatic cleaning and hair-removing slant brush according to claim 1, wherein the bristles and the bristle fixed surface are fixed in an inclined angle of 40-80 degrees.

4. The automatic cleaning and hair-removing slant brush according to claim 3, wherein an anti-slipping positioning frame is arranged aslant on the back side of the bristle holder; the anti-slipping positioning frame is a rectangular groove with an opening at one side; the through holes of the bristle holder are arranged in the anti-slipping positioning frame; the reciprocating moving plunger is wrapped by the anti-slipping positioning frame; and the height of the reciprocating moving plunger is less than that of the anti-slipping positioning frame.

5. The automatic cleaning and hair-removing slant brush according to claim 4, wherein the anti-slipping positioning frame and the back side of the bristle holder have an inclined angle of 40-80 degrees.

6. The automatic cleaning and hair-removing slant brush according to claim 5, wherein the anti-slipping positioning frame is parallel with the connecting rods.

7. The automatic cleaning and hair-removing slant brush according to claim 3, wherein the back side of the bristle holder is provided with a raised column; the raised column is parallel with the connecting rods; the raised column is arranged in the centre of the through holes; an elastic element is arranged between the raised column and the reciprocating plunger; and one end of the elastic element is buckled on the raised column and the other end of the elastic element is abutted against the reciprocating moving plunger.

8. The pet brush according to claim 1, wherein the back side of the bristle holder is provided with a handle connector; the handle connector is connected with a hollow comb handle; and a fixed rib is penetrated in the middle of the hollow comb handle.

9. The pet brush according to claim 8, wherein the edges at two ends of the hollow comb handle are respectively provided with an anti-slipping edge.

10. The pet brush according to claim 1, wherein the stroke of the reciprocating plunger is more than the vertical length of the bristles.
